(19) United States
(12) Patent Application Publication
(10) Pub. No.: US 2016/0092150 A1
(43) Pub. Date: Mar. 31, 2016

(54) USER INTERFACE FOR A DOCUMENT PROCESSING SYSTEM

(71) Applicant: OCÉ-TECHNOLOGIES B.V., Venlo (NL)

(72) Inventors: Richard M. DE GROOT, Venlo (NL); Pieter VERDUIN, Venlo (NL)

(73) Assignee: OCÉ-TECHNOLOGIES B.V., Venlo (NL)

(21) Appl. No.: 14/866,069

(22) Filed: Sep. 25, 2015

(30) Foreign Application Priority Data
Sep. 26, 2014 (EP) 14186640.0

(51) Int. Cl. G06F 3/12

(52) U.S. Cl. CPC G06F 3/1296; G06F 3/1217; G06F 3/1207

(57) ABSTRACT

A user interface for a document processing system includes a scheduler adapted to calculate and display an expected processing time for a job to be processed. The scheduler has an input device permitting a user to input a calibration command causing the scheduler to apply a user-specific calibration function to the calculated expected processing time.

### CROSS-REFERENCE TO RELATED APPLICATIONS

This application claims priority under 35 U.S.C. §119(a) to Application No. 14186640.0, filed in Europe on Sep. 26, 2014, the entire contents of which is hereby incorporated by reference into the present application.

### BACKGROUND OF THE PRESENT INVENTION

1. Field of the Invention

The present invention relates to a user interface for a document processing system, comprising a scheduler adapted to calculate and display an expected processing time for a job to be processed.

More particularly, the present invention relates to a user interface of a high production printing and/or copying system to which print or copy jobs are submitted by a plurality of users, either locally at the machine or from remote work stations that are connected to the document processing system via a network. Typically, the jobs to be processed involve printing of a large number of copies, so that the processing time for completing a job may be in the order of magnitude of several minutes or even hours. Then, it is desirable for the users to know the expected job processing time and, consequently, an estimate of the time when the job will be ready, so that the printed copies can be fetched from the machine.

2. Description of Background Art

It is known to calculate an estimate for the processing time by means of a scheduling algorithm that takes into account the number of copies or prints to be made, the printing speed, necessary time gaps between successive copy sheets, extra times for reversing the sheets in case of duplex printing, times required for heat-fusing toner images on the sheets, and the like. Some of these factors may also depend upon the current state and operating condition of the printing system, e.g. the current temperature of fuse stations, humidity and temperature of ambient air, and the like. When the document processing system also includes finishers or other accessory equipment for sorting, collating, stapling, punching or folding the printed sheets, the times required for these operations will also have to be taken into account.

Nevertheless, even when relatively complex scheduling algorithms are used, the processing time can only be predicted with a limited accuracy. The reason is that many of the factors that have to be taken into account are subject to statistical variations and cannot be known accurately. For example, in a printing system, a relatively time-consuming step that has to be performed for each page to be printed is the so-called raster image processing (RIP), wherein print data that are given in a page description language are converted into a bitmap suitable for driving the printing elements of the printer. This process may involve relatively complex calculations to be carried out by an electronic data processing system, and the calculation time will depend upon the contents to be printed, e.g. whether the image is a black/white image or a color image, contains photographs or graphic art or text only, and the like, so that the time needed for RIP may vary from print to print within a relatively large range.

It is possible to improve the prediction accuracy by calculating corrections while the print process is running already, based on the time that has been needed for the prints that have been made so far. However, this does not reduce the uncertainty at the time when the user submits the job.

### SUMMARY OF THE INVENTION

It is an objection of the present invention to improve the prediction accuracy of the scheduler at the time when a job is submitted.

In order to achieve this object, according to the present invention, the scheduler has an input device permitting a user to input a calibration command causing the scheduler to apply a user-specific calibration function to the calculated expected processing time.

The present invention is based on the consideration that the prediction accuracy can be improved significantly when the scheduler is specifically calibrated for each individual user. The reason is that, typically, each user will normally submit certain types of jobs that have similar characteristics. Consequently, the variation of the processing time per document for the jobs of an individual user will normally be significantly smaller than the variation of the processing times per document in the entire spectrum of jobs that may be submitted by any user. The prediction accuracy can therefore be improved when the user is given the possibility to input a calibration command that implicitly or explicitly specifies a calibration of the scheduling algorithm for the type of job the user is (normally) submitting.

More specific optional features of the invention are indicated in the dependent claims.

In a preferred embodiment, the scheduler is adapted to perform, upon a command from the user, a calibration routine that comprises the steps of:

prompting the user to submit a certain number of sample documents for processing;

calculating an expected processing time for the job consisting of the submitted sample documents;

commanding the document processing system to process the sample documents and counting the processing time that is actually needed for the sample documents; and

comparing the counted processing time to the calculated expected processing time and defining a calibration function based on the result of the comparison.

In a preferred embodiment, the calibration function will include a multiplication of the calculated expected processing time with a certain calibration factor and/or the addition of a certain offset to the calculated expected processing time. Both the calibration factor and the offset may optionally be edited by the user.

When the calibration is based on sample documents, at least the calibration factor will be calculated by the scheduler in accordance with the relation between the expected processing time and the actual processing time. Optionally, the user may still have the possibility to modify the calibration factor, e.g. by manually inputting a second calibration factor that will then be multiplied with the calibration factor calculated by the scheduler. The second calibration factor will reflect personal preferences and/or experiences of the user or his or her personal judgment on the nature of the documents to be processed.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a document processing system to which the present invention is applicable; and

FIGS. 2 to 6 are examples of windows displayed on a user interface of the document processing system under the control of a scheduler.

### DETAILED DESCRIPTION OF THE PREFERRED EMBODIMENTS

The present invention will now be described with reference to the accompanying drawings, wherein the same reference numerals have been used to identify the same or similar elements throughout the several views.

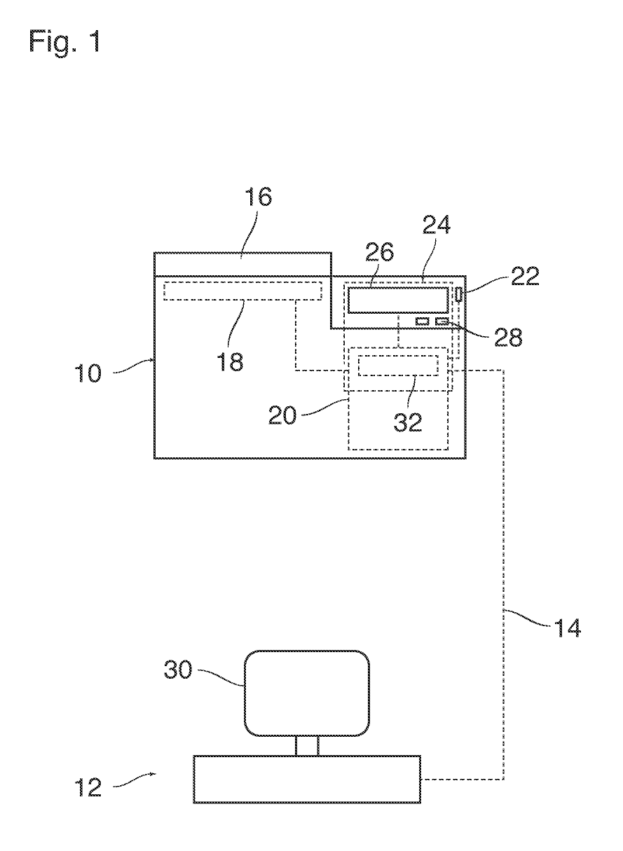

FIG. 1 illustrates a simple example of a document processing system comprising a high production digital printer 10 (with scanning and copying functions) and at least one remote work station 12 connected to the printer 10 via a network 14.

The printer 10 has a document feeder 16 and a scan unit 18 for feeding and scanning originals of documents to be copied. An electronic control unit 20 of the printer is connected to the scan unit 18 and to the network 14 for receiving print files either from the scan unit 18 or from the remote work station 12 and converting them into bitmap data that are suitable for driving a print engine (not shown) of the printer. In the example shown, print data may also be read from a portable memory device (e.g. a USB stick) that may be plugged into a socket 22.

The printer 10 further has a user interface 24 that is constituted in this example by a display screen 26, e.g. a touch-screen, and input buttons 28 on a control panel of the printer and by related software in the control unit 20, capable of controlling the display screen 26 and also capable of remote-controlling a display screen 30 of the work station 12, via a printer driver installed in the work station.

As is generally known in the art, the user interface 24 permits a user to enter job specifications for his print jobs either locally at the printer 10 or remotely from his work station 12.

A specific software module in the software of the user interface 24 is a scheduler 32 that is capable of calculating an expected processing time for a job to be processed, on the basis of the job specifications and the current status of the printer 10. Thus, when the user has submitted his print file and has entered the related job specifications, including among others the number of copies to be made, the scheduler 32 will calculate an estimate of the time that will be needed for processing the print job, and this time will be displayed on the local display screen 26 and/or the remote display screen 30.

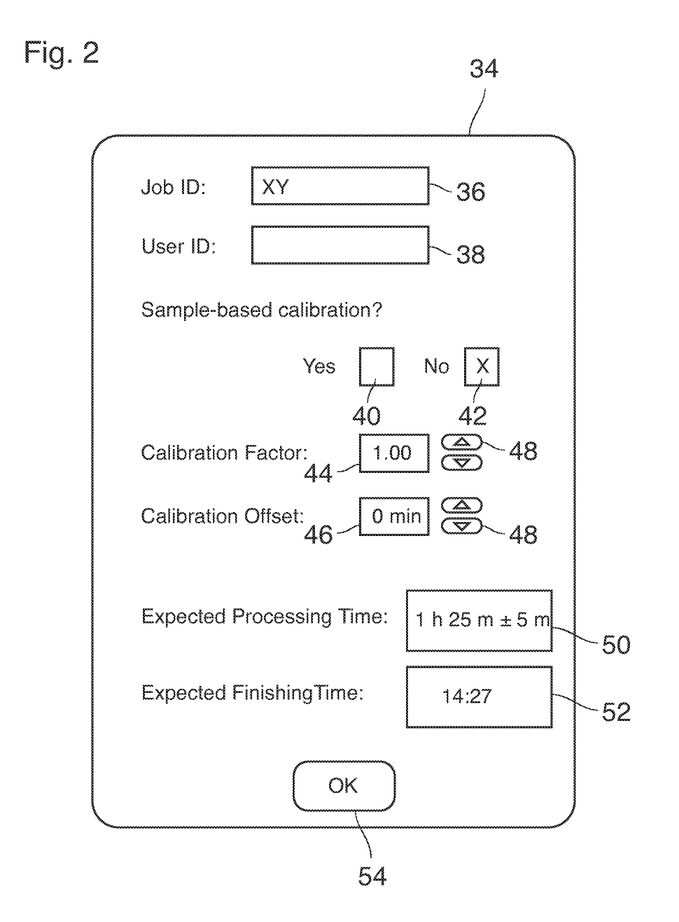

FIGS. 2 to 6 are examples of different contents of a window 34 that is displayed on the screen 26 or 30 under the control of the scheduler 32.

FIG. 2 illustrates a case where the user has entered the job specification locally at the control panel of the printer 10. A job ID “XY” has automatically been assigned to the job and is displayed in a field 36 of the window 34. Another field 38 is provided for displaying and/or entering a user ID. However, in the present example, the user has not identified themself, so that the field 38 is empty.

Check boxes 40, 42 permit the user to enter a command for performing a calibration routine that is based on the processing of sample documents. In this example, no such calibration routine is to be performed.

A display field 44 indicates a default setting “1.00” of a calibration factor, and a field 46 indicates a default setting “0 min” of a calibration offset. Buttons 48 permit the user to increment or decrement the calibration factor and the calibration offset.

A field 50 is used for displaying the expected processing time as calculated by the scheduler 32. In the given example, the expected processing time for the print job is 1 h 25 m, with an expected tolerance of ±5 m.

Another field 52 is used for displaying the time “14:27” at which the print job is expected to be ready. If the printer is not busy with printing another job, the expected finishing time will be the present time plus the processing time as displayed in the field 50. If the printer is still busy and the job that is presently being submitted is added at the end of a print queue, then the expected finishing time displayed in the field 52 will be the present time plus the expected processing times of all earlier jobs being processed and waiting in the print queue, respectively, plus the processing time for the present job as displayed in the field 50.

When the user does not want to calibrate the scheduler 32, he will simply press a button 54 “OK”, in order launch the print job.

It will be understood that, if the window 34 is displayed on the local screen 26, which is a touch-screen, the check boxes 40, 42 can simply be ticked with a finger, the buttons 48 and 50 are also activated by a finger touch, and the display fields can be activated by a finger touch, and alphanumeric data can be entered via a keyboard (not shown). When the window 34 is displayed on the remote screen 30, the buttons and check boxes can be ticked with a mouse click and the other fields can be edited via a keyboard of the work station 12.

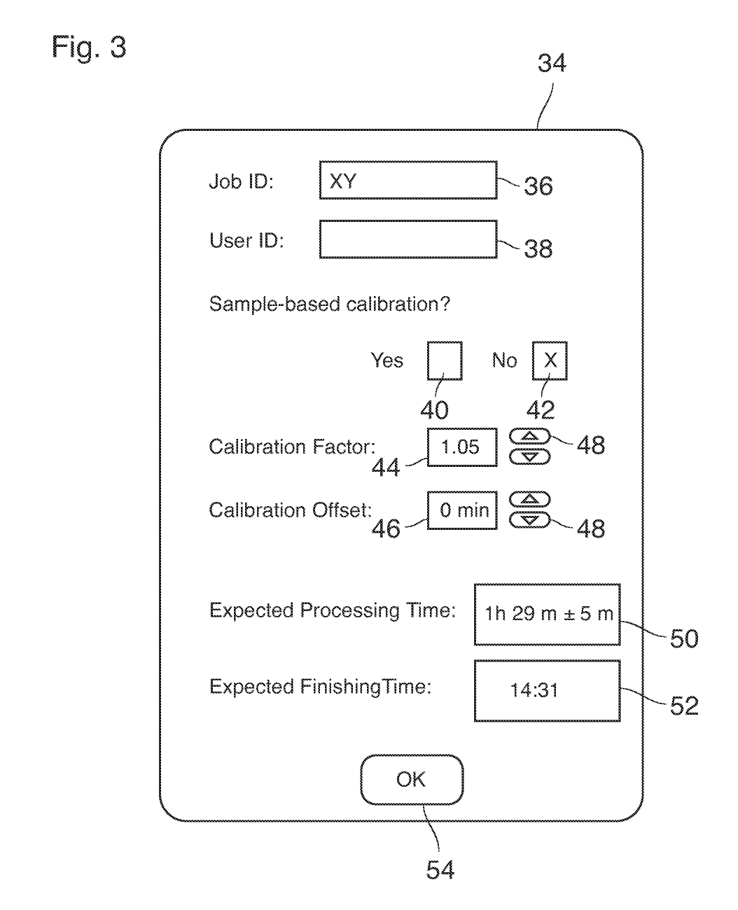

FIG. 3 illustrates an example where the user has entered a calibration command that consists in changing the calibration factor from 1.00 to 1.05. This has the effect that the expected processing time as displayed in the field 50 is multiplied by the calibration factor 1.05, i.e. increased by 5% (corresponding to 4 minutes in this example). Thus, when the user has experienced that the expected processing times that are displayed for his print jobs in the field 50 are always about 5% too small, he user may choose to calibrate the scheduler 32 by entering the calibration factor of 1.05, so that he may then obtain a more realistic indication of the time when the job will be finished directly from the field 52.

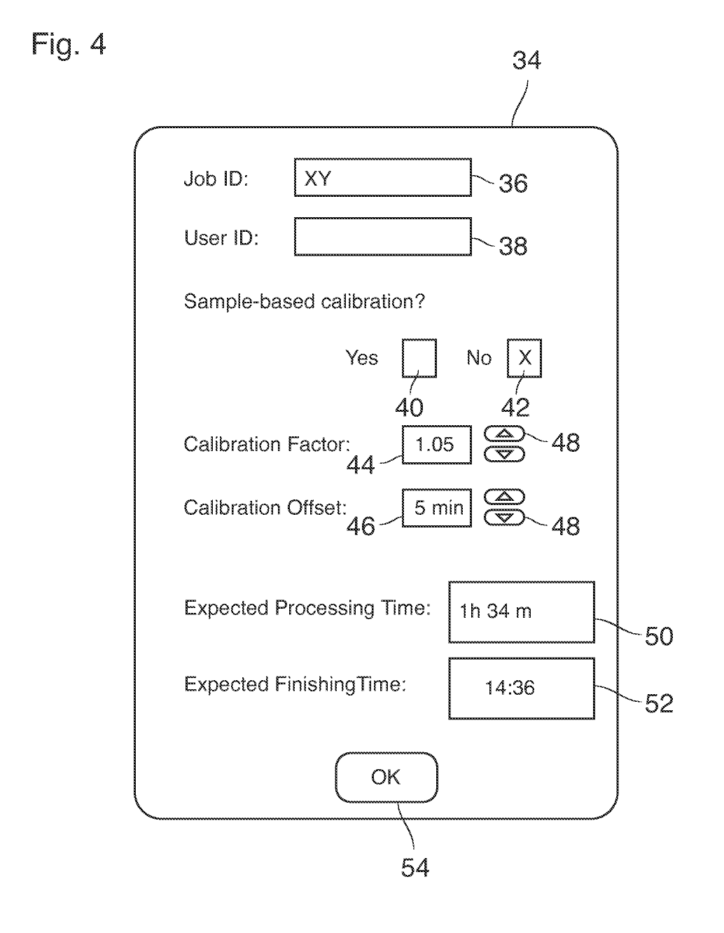

FIG. 4 illustrates an example where the user has additionally entered a calibration offset of 5 min in the field 46. Consequently, the expected processing time in the field 50 has been increased by another 5 min, and the expected finishing time in the field 52 has been increased accordingly.

In general, a calibration function f that is applied to the expected processing time t₀ as calculated by the scheduler 32 (and displayed in the field 50 in FIG. 2) has the form:

f(t₀)=t₀*1.05+5

wherein “a” is the calibration factor shown in the field 44 and “c” is the offset shown in the field 46.

Thus, the settings of the calibration factor and calibration offset in FIG. 4 result in a calibration function:

f(t₀)=t₀*1.05+5

when the time is counted in minutes.

In the example shown in FIG. 4, no tolerance is indicated in the field 50, because it is assumed that the tolerance is absorbed in the offset entered by the user.

In general, the calibration offset will be selected by the user such that he can be relatively sure that his job will actually be ready when he arrives at the printer at the “Expected Finishing Time” as indicated in the field 52. Thus, the calibration offset will mainly reflect personal preferences of the user.

When several print jobs are waiting in a print queue, the expected processing times for all these jobs are needed for calculating the expected finishing time for the last job. However, for the purpose of calculating the expected finishing time, it will be useful to neglect the calibration offsets that have been entered by the users for the earlier jobs. On the other hand, it may be useful to keep the calibration factors that have been entered by the users, because these factors will generally reflect the experiences of these users and may therefore lead to a more realistic result than the original calculation performed by the scheduler 32.

When a print job is submitted remotely from the work station 12, the identity of the user can of course be inferred from the communications protocol that is used for data traffic via the network 14, and a corresponding user ID will then automatically be entered in the field 38. Optionally, the last settings of the calibration factor and of the calibration offset may be stored for each individual user, so that, whenever a user is identified by his or her ID, the stored settings for the calibration factor and for the calibration offset will automatically be taken as the default settings in the fields 44 and 46.

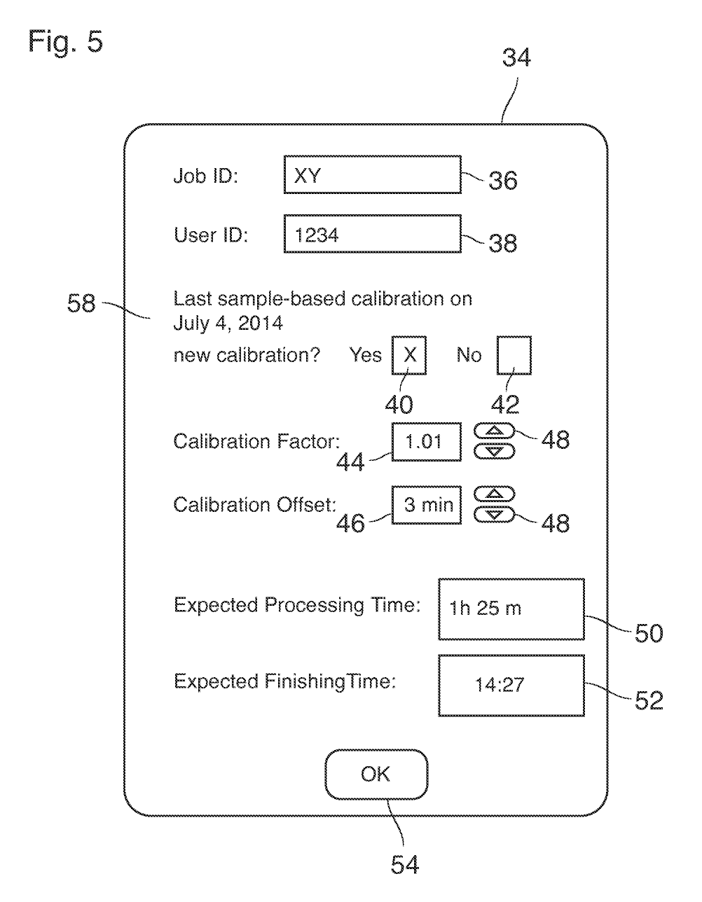

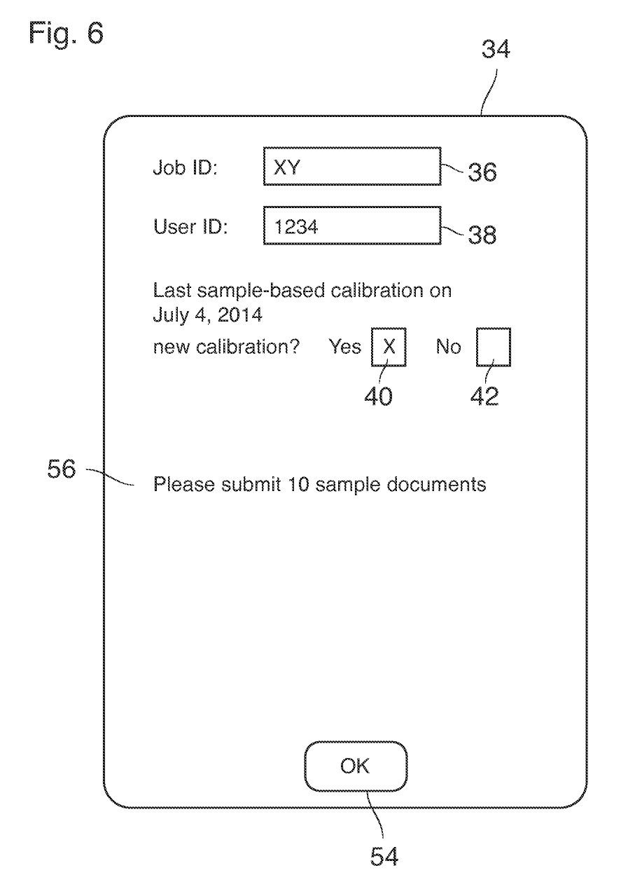

FIGS. 5 and 6 illustrate an example where the user has chosen to perform a sample-based calibration routine by checking the box 40 (FIG. 5). Then, when the user presses the “OK” button 54, the contents of the window 34 will change to what is shown in FIG. 6. A message 56 prompts the user to submit a number (10 in this example) of sample documents. The user will thereupon submit 10 documents that are typical for the type of documents he usually wants to have processed. If the job is a copy job, the sample documents may be scanned-in with the scan unit 18. If the job data are entered via the USB socket 22 or via the network 14, and the submitted job includes at least 10 pages, then the control unit 20 may just take the first 10 pages of the print job as sample documents. As an alternative, the user may send a specific sample file including the 10 sample documents from his work station 12.

The scheduler 32 will apply its scheduling algorithm to calculate an expected processing time for the sample job. Then, the control unit 20 of the printer is caused to process (print) the sample documents, and the time needed for this process will be counted. Finally, the scheduler 32 compares the counted time to the calculated expected processing time and defines a calibration function on the basis of the comparison result. For example, the calibration function may be defined by setting the calibration factor “a” to the value that is obtained by dividing the counted time that has actually been needed for printing by the calculated time (and setting the offset “c” to zero or leaving it as it is).

When the user has submitted the sample documents, he or she will press the “OK” button 54, and the contents of the window 34 will switch back to what is shown in FIG. 5. In this window, the field 44 will show the calibration factor (1.01 in this example) that has been calculated on the basis of the sample documents. However, it is still possible for the user to edit this calibration factor afterwards.

In this case, the calibration function may take the form:

f(t₀)=t₀*a*b

wherein “a” is the calibration factor that has been calculated by the scheduler 32 on the basis of the sample documents, and “b” is the calibration factor that the user has manually entered in the field 44 after the factor “a” has been calculated and displayed.

In another embodiment, when the user enters a calibration factor “b” in the field 44, the calibration function may be:

f(t₀)=t₀*b

i.e. the factor “a” that has been calculated on the basis of the sample documents is just a proposal that the user may accept or reject.

In addition, the user may enter a calibration offset in the field 46.

In the example shown in FIGS. 4 and 5, the user has been identified by an ID, which is indicated in the field 38. In this case, in the window shown in FIG. 5, a message 58 advises the user of the date when the last sample-based calibration has been made. So, the user may decide whether or not he wants to re-calibrate the scheduler by checking one of the boxes 40, 42. If the user checks the box 42 “No”, the previously stored user-edited settings for the calibration factor in the field 44 and the calibration offset in the field 46 will be retained.

If the operating conditions of the printer 10 at the time when the sample-based calibration is performed are not the “normal” conditions, e.g. if the processing of the sample document is delayed because the printer does not have its normal operating temperature and some additional time is needed for warning-up, then this additional time may be subtracted before the calibration factor is corrected.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A user interface for a document processing system, comprising:
a scheduler adapted to calculate and display an expected processing time t₀ for a job to be processed,
wherein the scheduler has an input device permitting a user to input a calibration command causing the scheduler to apply a user-specific calibration function f(t₀) to the calculated expected processing time.

2. The user interface according to claim 1, wherein the scheduler is adapted to perform, upon a calibration command from the user, a calibration routine that comprises the steps of:
prompting the user to submit a number of sample documents to be processed;
calculating the expected processing time t₀ for the job consisting of the submitted sample documents;
causing the processing system to process the sample documents and counting the time needed for processing the sample documents; and
comparing the counted time to the calculated expected processing time t₀ for the sample documents and calculating the calibration function f(t₀) on the basis of the comparison result.

3. The user interface according to claim 1, wherein the calibration function f(t₀) has the form
f(t₀)=a*t₀+c,
wherein a is a predetermined calibration factor and c is a predetermined calibration offset.

4. The user interface according to claim 2, wherein the calibration function f(t₀) has the form
f(t₀)=a*t₀+c,
wherein a is a predetermined calibration factor and c is a predetermined calibration offset.

5. The user interface according to claim 4, wherein the scheduler is adapted to define the calibration function on the basis of the comparison result by calculating and setting the calibration factor a.

6. The user interface according to claim 3, wherein the calibration factor a and/or the calibration offset c is user-editable.

7. The user interface according to claim 5, wherein the calibration factor a and/or the calibration offset c is user-editable.

8. The user interface according to claim 6, wherein the scheduler is adapted to store default settings for the calibration factor a and/or the calibration offset c for each user that is identified by a user ID.

9. The user interface according to claim 6, wherein the scheduler is adapted to store default settings for the calibration factor a and/or the calibration offset c for each user that is identified by a user ID.
